(19) United States
(12) Patent Application Publication
(10) Pub. No.: US 2004/0130387 A1
(43) Pub. Date: Jul. 8, 2004

(54) Logic circuitry with reduced standby leakage using charge pumped switches

(76) Inventor: Andrew Marshall, Dallas, TX (US)

Correspondence Address: Rose Keagy, Texas Instruments Incorporated, M/S 3999, P.O. Box 655474, Dallas, TX, 75265, US

(21) Appl. No.: 10/337,078

(22) Filed: Jan. 6, 2003

(51) Int. Cl. G05F 1/10

(52) U.S. Cl. 327/544

(57) ABSTRACT

The present invention achieves technical advantages as control circuitry (52) enabled to establish logic circuitry (12) in a deep-sleep mode by stopping the oscillator of the charge pump when the associated logic circuitry is put into the deep-sleep mode. Advantageously, the same control signal (44) utilized to control the header switch (22) is also coupled to and controls the oscillator signal (54) such that the charge pump circuitry is switched into high impedance mode. Advantageously, the control circuitry of the present invention achieves the requirements of a high impedance off state, enables the charge pump to operate below the supply voltage, and without having to use an expensive triple well semiconductor process.

### FIELD OF THE INVENTION

The present invention is generally related to integrated electronic circuits, and more particularly to integrated circuits having a deep-sleep mode including logic circuitry and memory devices.

### BACKGROUND OF THE INVENTION

Conventional electronic circuits, including logic circuitry, memory devices and so forth, operate off of supply voltages and are designed to consume the least amount of power possible. Reducing power consumption allows the circuitry to be physically reduced in size, and operate extended periods of time off of battery power when utilized.

It has become increasing important to place this integrated circuitry into a deep-sleep mode to minimize circuit leakage to reduce battery drain. Referring to FIG. 1, there is shown a conventional approach at 10 whereby logic circuitry 12 is electrically connected between a voltage source 14 and a voltage reference 16. This logic circuitry 12 may be switched completely off, i.e. put in a deep-sleep mode, using a series switch 18 at the base of the circuitry 12, shown as a footer switch 18, and thus generating a voltage Vssinternal at the circuitry. To switch off the circuitry 12, a logic signal is provided to input line 19 thereby turning off footer switch 18. The problem encountered when using this footer switch 18 is that a PMOS tank in the logic circuitry 12 is still connected to upper voltage supply 14, thereby disadvantageously providing a current leakage path to ground that is not switched. Further, gate leakage paths in the logic circuitry 12 are still provided to ground.

Referring now to FIG. 2, there is shown at 20 the use of a header switch 22 rather than the footer switch 18, wherein like numerals refer to like elements. Similarly, a logic signal provided to input 19 turns off the header switch 22 to thereby remove the upper voltage source from the associated logic circuitry 12. Typically, this header switch 22 is a PMOS device that is much larger than the equivalent NMOS device 18 shown in FIG. 1, and introduces a higher leakage. A conventional PMOS device used as header switch 22, which may be used with logic circuitry 12 being logic, memory circuitry, etc would have to be 3-4×larger than the equivalent NMOS device.

Referring now to FIG. 3, there is shown at 30 a conventional implementation of a switched negative voltage charge pump for controlling the header switch 22 such that the effective Rsdon is improved. A charge pump circuitry 40 is seen to receive an oscillator signal at input 42, and a sleep mode control signal on line 44. Conventionally, a logic signal provided on input line 44 selectively controls the application of the free running oscillator signal to the gate of header switch 22. In this embodiment the oscillator signal provided at input 42 is free running, and only the transistors driven by the sleep control signal on line 44 are controlled.

However, the control circuitry 40 cannot be fabricated and switched efficiently without a triple well semiconductor process which is an expensive process.

### SUMMARY OF THE INVENTION

The present invention achieves technical advantages as control circuitry enabled to establish logic circuitry in a deep-sleep mode and also stopping the charge pump when the associated logic circuitry is put into the deep-sleep mode. Advantageously, a common control signal is utilized to control the header switch and also controls the oscillator signal such that the charge pump circuitry is switched into high impedance mode Advantageously, the control circuitry of the present invention achieves the requirements of a high impedance off state, and also enables the charge pump to operate below the supply voltage, and also without having to use an expensive triple well or silicon on insulator semiconductor process.

### BRIEF DESCRIPTION OF THE DRAWINGS

FIG. 1 is a schematic diagram of a conventional sleep mode control circuitry utilizing a footer switch;

FIG. 2 is a schematic diagram of a conventional sleep mode control circuitry utilizing a header switch;

FIG. 3 is a schematic diagram of a switched negative voltage charge pump controlling a header switch and which requires a triple well fabrication process (or SOI) to avoid parasitics in the associated NMOS transistor;

FIG. 4 is a schematic diagram of one embodiment of the present invention which includes a switched negative voltage charge pump having an oscillator disengaged when the associated circuitry is put into the sleep mode, and which does not require a triple well fabrication (or SOI) process;

FIG. 5 is a detailed schematic of the present invention;

FIG. 6 is an alternative embodiment of the present invention which includes a switched negative voltage charge pump having an oscillator disengaged when the associated circuitry is put into the sleep mode, and which does not require a triple well fabrication (or SOI) process, showing the implementation as a voltage doubler type charge pump; and

FIG. 7 is a schematic diagram of another embodiment of the present invention which includes a switched negative voltage charge pump, using a large NMOS, which is sized to ensure it's drain does not go significantly below the substrate voltage.

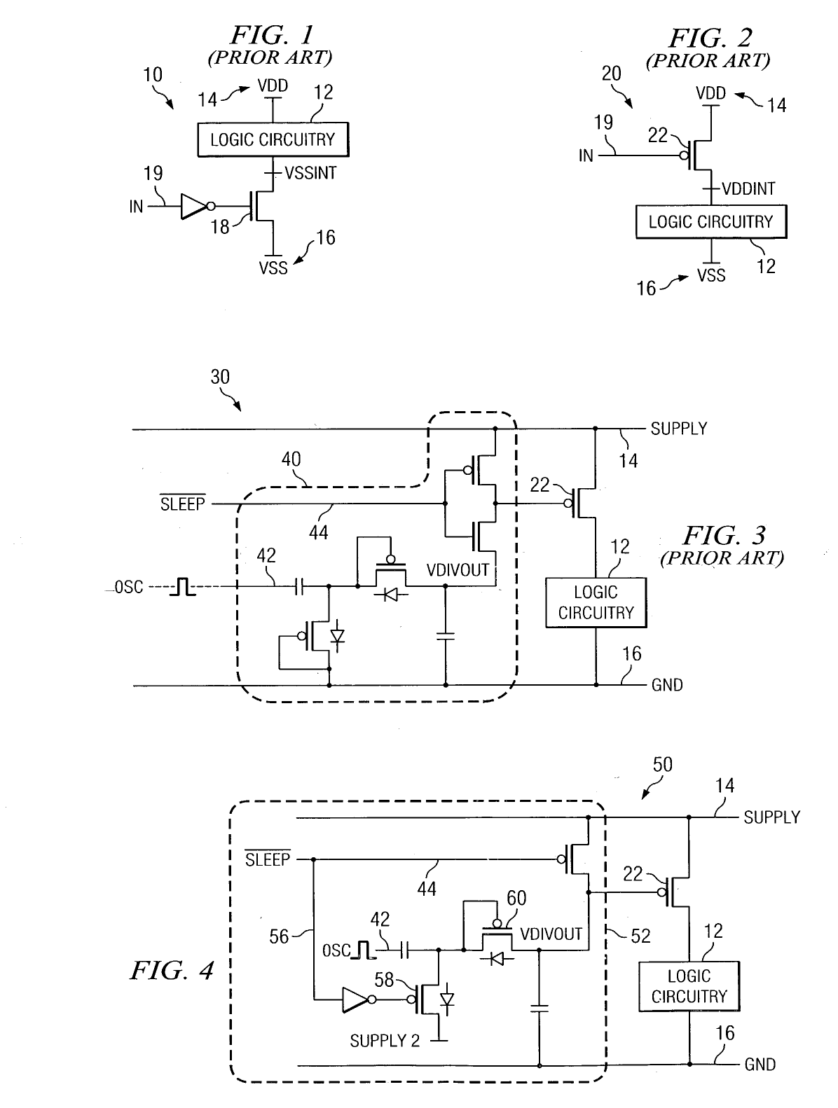

### DETAILED DESCRIPTION OF THE PREFERRED EMBODIMENT

Referring now to FIG. 4, there is generally shown at 50 one embodiment of the present invention seen to include the header switch 22 advantageously charged pumped to a negative voltage by a charge pump circuitry 52 according to the present invention. Circuitry 52 is seen to include circuitry which achieves the requirements of a high impedance off state, and enables the charge pump circuitry 52 to operate below the supply voltage. In addition, this control circuitry 52 can advantageously be fabricated without using the expensive triple well process.

Still referring to FIG. 4, it can be seen that the oscillator signal is provided to input line 42 as previously described. However, the sleep mode control signal provided at input 44 is also provided at input 56 to inhibit the oscillator signal and provide a high impedance state This control circuitry 52 charge pumping the gate of header switch 22 to a negative voltage has minimum power dissipation when the logic 12, and other associated circuitry, is in the sleep state. Moreover, the header switch 22 advantageously can be a reduced area PMOS header switch. The present invention both maintains the lowest power and uses a conventional CMOS (non-triple well) fabrication process.

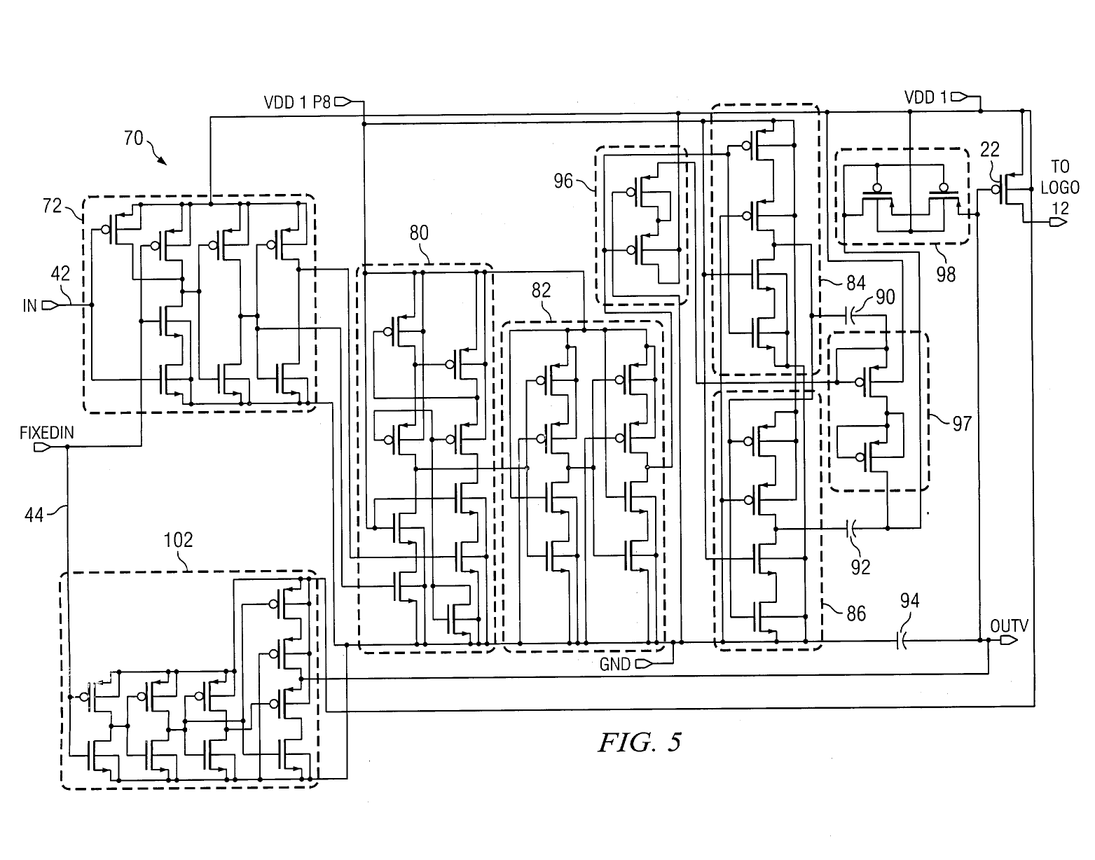

Turning now to FIG. 5, there is shown a detailed schematic of the present invention at 70, with portions of the circuitry labeled into blocks and which provide the following functions. Circuit block 72 provide input control logic which receives an oscillating square wave input signal at 74 typically in the range of 10 to 100 MHz. A control signal is provided at input 76 and provides an on/off signal designating when the output transistor is to be turned on or off.

Block 80 is a voltage level shifter circuit, which in this preferred embodiment the input voltage ranges between 0 and 1.2 volts, and possibly up to between 0 and 1.8 volts.

Circuit block 82 is seen to be a current amplifying buffer which drives circuit block 84, which is the charge pump driver, and also drives circuit block 86 which is the driver bar.

Circuit block 90 and 92 are charging or bucket capacitors. Circuit block 94 is a storage capacitor. Circuit blocks 96, 97 and 98 are unidirectional switches, operating as diodes, which are configured to only pass current in one direction.

Circuit block 102 is an output control circuit that has the dual task and capability of rapid turn-on of the drive transistor 104, and also complete turn-off of the same transistor 104 in the off state. In this embodiment, the drive transistor 104 also acts as a storage element.

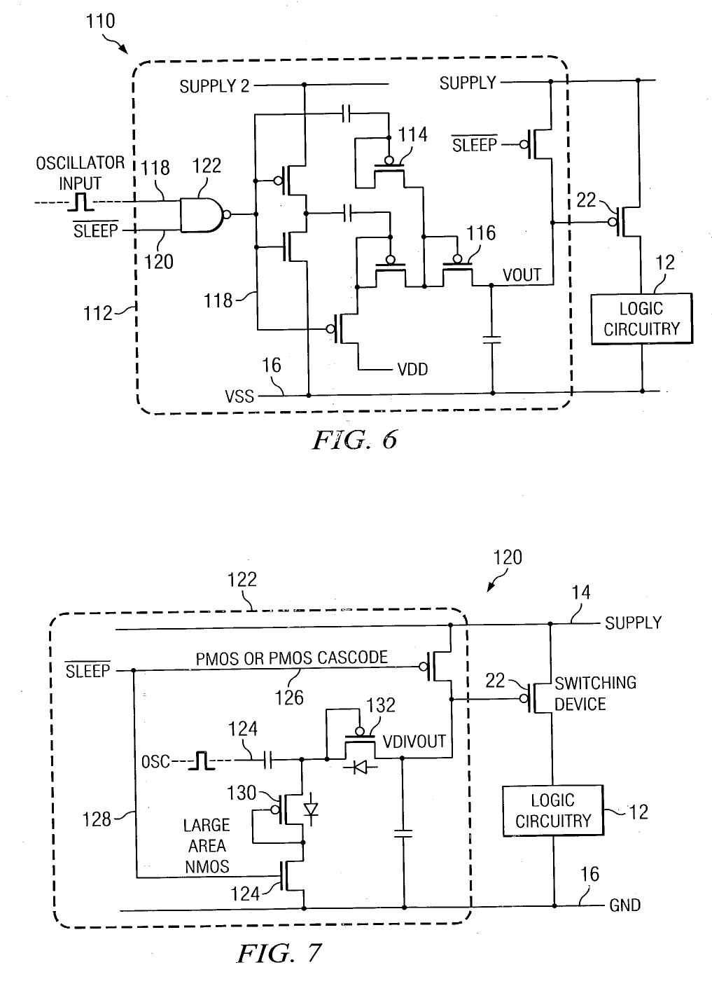

Referring now to FIG. 6, there is shown at 110 a voltage doubler version of that shown at 50 in FIG. 4, (which is a so-called voltage tripler configuration). In this embodiment of the present invention the header switch 22 is advantageously charged pumped to a negative voltage by a charge pump circuitry 112 according to the present invention. Circuitry 112 is seen to include circuitry comprising gate 114 and transistor 116 which achieves the requirements of a high impedance off state, and enables the charge pump circuitry 112 to operate below the supply voltage. In addition, this control circuitry 112 can advantageously be fabricated without using the expensive triple well process.

Still referring to FIG. 6, it can be seen that the oscillator signal is provided to input line 118. However, the sleep mode control signal provided at input 120 of NAND gate 122 inhibit the oscillator signal and provide a high impedance state. This control circuitry 112 charge pumping the gate of header switch 112 to a negative voltage has minimum power dissipation when the logic 12, and other associated circuitry, is in the sleep state. Moreover, the header switch 22 advantageously can be a reduced area PMOS header switch. The present invention both maintains the lowest power and uses a conventional CMOS (non-triple well) fabrication process.

Referring now to FIG. 7, there is generally shown at 120 another embodiment of the present invention seen to include the header switch 22 advantageously charged pumped to a negative voltage by a charge pump circuitry 122 according to the present invention. Circuitry 122 is seen to include an additional NMOS transistor 124 which is sized large enough that in the on-state its drain voltage can never become significantly below ground. This circuitry 122 achieves the requirements of a high impedance off state, and enables the charge pump circuitry 122 to operate below the supply voltage. In addition, this control circuitry 122 can advantageously be fabricated without using the expensive triple well process.

Still referring to FIG. 7, it can be seen that the oscillator signal is provided to input line 124 as previously described. However, the sleep mode control signal provided at input 126 is also provided at input 128 to the gate of the NMOS transistor 124. Advantageously, when the logic circuitry 12 is put into the deep sleep mode, the sleep logic signal provided at input 126 not only turns off the header switch 22, the sleep control signal provided at input 126 also turns off the NMOS transistor 124. Transistor 124 is connected in series with transistors 130 and 132 and thus stops the oscillator signal from being provided to the gate of header switch 22 to advantageously create a low current in the control circuitry 122 during the deep sleep mode. This control circuitry 122 charge pumping the gate of header switch 122 to a negative voltage has minimum power dissipation when the logic 12, and other associated circuitry, is in the sleep state. Moreover, the header switch 22 advantageously can be a reduced area PMOS header switch. The present invention both maintains the lowest power and uses a conventional CMOS (non-triple well) fabrication process.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A circuit, comprising:
an upper voltage source;
a lower voltage reference;
a logic circuit;
a header switch coupled between the upper voltage source and the logic circuit; and
a charge pump circuit enabled by a control signal and controllably coupled to the header switch, the charge pump circuit selectively providing a voltage signal to the header switch when the logic circuit is operable, and whereby the oscillator signal is stopped upon the logic circuit being enabled into a sleep state.

2. The circuit as specified in claim 1 further comprising a control switch selectively enabling and disabling the oscillator signal.

3. The circuit as specified in claim 2 wherein the control switch is disposed between the charge pump circuit and the lower voltage reference.

4. The circuit as specified in claim 3 wherein the control switch is a NMOS transistor.

5. The circuit as specified in claim 2 wherein the control switch is also controlled by the control signal.

6. The circuit as specified in claim 2 wherein the charge pump circuit and the control switch are formed using a conventional CMOS semiconductor process.

7. The circuit as specified in claim 3 wherein the charge pump circuit and the control switch are formed using a conventional CMOS semiconductor process.

8. The circuit as specified in claim 2 wherein the control switch is coupled in series with the charge pump circuit and couples the oscillator signal to the lower voltage reference when enabled.

9. The circuit as specified in claim 3 wherein the control switch is coupled in series with the charge pump circuit and couples the oscillator signal to the lower voltage reference when enabled.

10. The circuit as specified in claim 2 wherein the header switch comprises a first and second cascaded PMOS transistor.

11. The circuit as specified in claim 3 wherein the header switch comprises a first and second cascaded PMOS transistor.

12. The circuit as specified in claim 10 wherein the control signal is coupled to a gate of said first PMOS transistor and said oscillator signal is coupled to a gate of the second PMOS transistor.

13. The circuit as specified in claim 11 wherein the control signal is coupled to a gate of said first PMOS transistor and said oscillator signal is coupled to a gate of the second PMOS transistor.

14. The circuit as specified in claim 12 wherein the oscillator circuit comprises a third and fourth PMOS transistor coupled in series with an oscillator signal provided at a node therebetween, said third PMOS transistor being coupled to the gate of first PMOS transistor and the fourth PMOS transistor being coupled to the control switch.

15. The circuit as specified in claim 1 wherein the charge pump circuit provides a high impedance to the header switch when the oscillator is stopped.
